(19) United States
(12) Patent Application Publication
(10) Pub. No.: US 2018/0218857 A1
(43) Pub. Date: Aug. 2, 2018

(54) REDUCED LAYER KEYBOARD STACK-UP

(71) Applicant: Apple Inc., Cupertino, CA (US)

(72) Inventors: Robert Y. Cao, San Francisco, CA (US); Dinesh C. Mathew, San Francisco, CA (US)

(21) Appl. No.: 15/940,909

(22) Filed: Mar. 29, 2018

Related U.S. Application Data
(63) Continuation of application No. 14/736,151, filed on Jun. 10, 2015, now Pat. No. 9,934,915.

(51) Int. Cl. H01H 13/702; H01H 13/02; H01H 13/704; H01H 13/705; H01H 3/12

(52) U.S. Cl. CPC H01H 13/702; H01H 13/023; H01H 13/704; H01H 13/705; H01H 2209/03; H01H 3/125; H01H 2219/036; H01H 2223/034; H01H 2231/042; H01H 2215/006

(57) ABSTRACT

Disclosed herein is a stack-up for an input device. The stack-up may include a flexible substrate having a switch and a light source. The switch has at least two contacts that are bridged in response to actuation of a dome that is positioned above the switch. The flexible substrate includes a signal trace for detecting the actuation of the dome and a power trace for providing power to the light source.

### FIELD

The described embodiments relate generally to an assembly for an input device. More particularly, the present embodiments relate to a keyboard stack-up for a keyboard assembly.

### BACKGROUND

Electronic devices typically include one or more input devices such as keyboards, touchpads, mice, or touchscreens to enable a user to interact with the device. These input devices can be integrated into an electronic device or can stand alone as discrete devices that transmit signals to the electronic device via a wired or wireless connection.

A conventional keyboard typically includes a dome switch, two layers (typically plastic) separated by a spacer and a contact switch coupled to a printed circuit board. Upon actuation of the dome, the first layer deflects and comes into contact with the second layer. As the layers contact one another, the switch closes and ultimately provides a detectable input. However, as more layers are included in the keyboard assembly, the overall thickness of the keyboard assembly increases. When a keyboard or other input device is integrated with an electronic device, particularly small or thin form factor electronic devices, the increased thickness of the keyboard assembly or input device may be undesirable.

### SUMMARY

Generally, embodiments disclosed herein are directed to an input assembly. The input assembly includes a top case defining a keyhole. The keyhole has a support structure that extends from a base of the opening to form a ledge or platform. The input assembly also includes a stack-up positioned on the support structure. The stack-up includes a substrate, an in-plane switch coupled to the substrate, and a dome positioned above the in-plane switch. The dome is adapted to cause the in-plane switch to conduct a signal in response to actuation of the dome.

Also disclosed is a stack-up for an input device. The stack-up includes a substrate. In some embodiments, the substrate may be flexible. A switch having at least two contacts is coupled to the substrate. An optional light source may also be coupled to the substrate. The stack-up also includes a dome positioned above the switch. Actuation of the dome causes a conductive material positioned above the switch to bridge the at least two contacts of the switch. The substrate contains a signal trace for detecting the actuation of the dome. When the light source is present, the substrate also includes a power trace for providing power to the light source.

In yet another embodiment, a stack-up for an input device may include a flexible substrate having a signal trace formed thereon. The stack-up also includes a switch having at least two contacts and a dome positioned above the switch. A conductive material may be integrated with a bottom surface of the dome. The conductive material of the dome bridges the at least two contacts of the switch in response to actuation of the dome.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates an example electronic device that may use the keyboard assembly and keyboard stack-up described herein according to one or more embodiments of the present disclosure;

FIG. 2 illustrates an example keyboard assembly according to one or more embodiments of the present disclosure;

FIG. 3A illustrates an example reduced layer keyboard stack-up including a keycap and a hinge mechanism according to one or more embodiments of the present disclosure;

FIG. 3B illustrate a top-down view of an example in-plane switch according to one or more embodiments of the present disclosure;

FIG. 4 illustrates an example reduced layer keyboard stack-up including a keycap and a hinge mechanism according to one or more alternate embodiments of the present disclosure; and

FIG. 5 illustrates a cross-section view of an example keyboard assembly according to one or more embodiments of the present disclosure.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates generally to various layers of components that form a keyboard assembly or an input assembly for an input device. The layers of the components are referred to herein as a “stack-up.” More specifically, the disclosure is directed to a reduced layer keyboard stack-up for a keyboard assembly or other input assembly of an electronic device. The stack-up may be reduced in size and some components or layers of the stack-up may be removed to reduce the overall size, dimension and/or thickness of the keyboard or input device.

Conventional keyboard stack-ups often include at least three discrete layers with each layer having a different thickness. More specifically, conventional keyboard stack-ups include a switch mounted on a polyethylene terephthalate (PET) membrane, a backlight layer that includes one or more light sources and one or more light guides, and a structural layer typically made of a stainless steel sheet metal. As the PET membrane deflects, electrical traces associated with the switch contact each other for an electrical make.

In contrast, the keyboard stack-up of the present disclosure uses a flexible substrate (such as a flex circuit) as the bottom layer for the switch. As such, one or more light sources may be coupled to the flexible substrate such that they are on the same layer as the switch. More specifically, the keyboard stack-up of the present disclosure utilizes an in-plane switch that enables the keyboard stack-up to have fewer layers, thereby reducing the overall thickness of the keyboard stack-up and any associated keyboard. Because the keyboard stack-up utilizes a flexible substrate, the keyboard stack-up, or an associated keyboard, may be manipulated, bent, or otherwise deflected, at least at particular points or portions. The reduced profile and the ability of the keyboard stack-up to be manipulated in such a manner may enable a keyboard assembly, and more particularly a top case of a keyboard assembly, to have additional support structures and/or increased thickness without increasing or unduly increasing the overall thickness of the keyboard and/or the electronic device. As such, the keyboard assembly may be used with electronic devices having a small form factor and/or a thin profile.

The reduced layer keyboard stack-up includes a flexible substrate, a dome, an in-plane switch and an optional light source. The in-plane switch and the light source are coupled to the flexible substrate. In some embodiments, the flexible substrate may also be laminated or coupled to a printed circuit board or other stiffener.

The in-plane switch includes two or more contacts that are bridged in response to contact from a conductive material. More specifically, as the dome is actuated, collapses or is otherwise compressed, a conductive material, either on a deflection layer of the stack-up or on the dome is brought into contact with the two or more contacts of the in-plane switch to conduct a signal. The signal may be transmitted along a signal trace that is embedded in or otherwise provided on the flexible substrate. In addition, a power trace may also be provided in or on the flexible substrate to provide power to the light source.

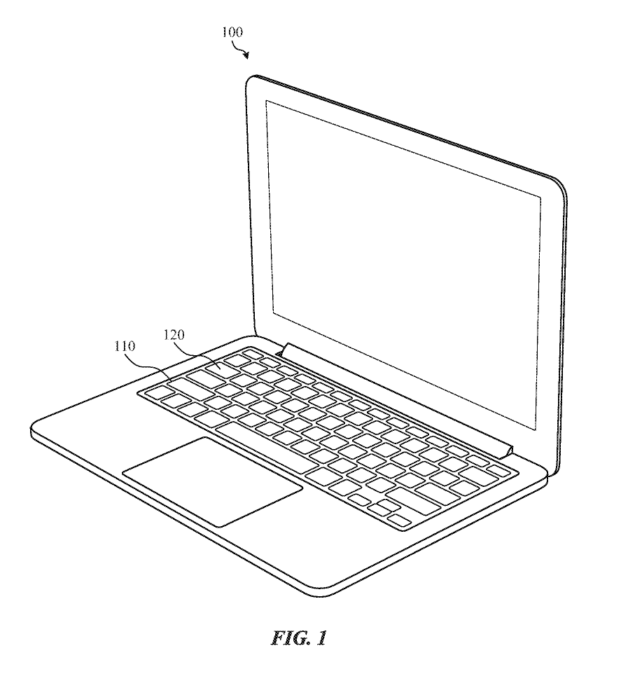

These and other embodiments are discussed below with reference to FIGS. 1-5. However, those skilled in the art will readily appreciate that the detailed description given herein with respect to these Figures is for explanatory purposes only and should not be construed as limiting.

FIG. 1 illustrates an example electronic device 100 that may use the keyboard assembly and keyboard stack-up described above and herein. In a non-limiting example, the electronic device 100 may be a laptop computer having an integrated keyboard 110. The keyboard 110 may include various keys 120. The keys 120 may each be associated with a respective keyboard stack-up such as described herein. Further, each key 120 may be supported by a support structure of a top case such as described below.

While a laptop computer is specifically shown and described, the electronic device 100 may be configured as any electronic device that may utilize the keyboard assembly and/or the keyboard stack-up described herein. For example, the electronic device 100 may be a desktop computer, a tablet computing device, a smartphone, a gaming device, a display, a digital music player, a wearable computing device or display, a health monitoring device, and so on. In addition, while a keyboard is specifically mentioned, the embodiments described herein may be used in a variety of input devices such as, buttons, switches and so on.

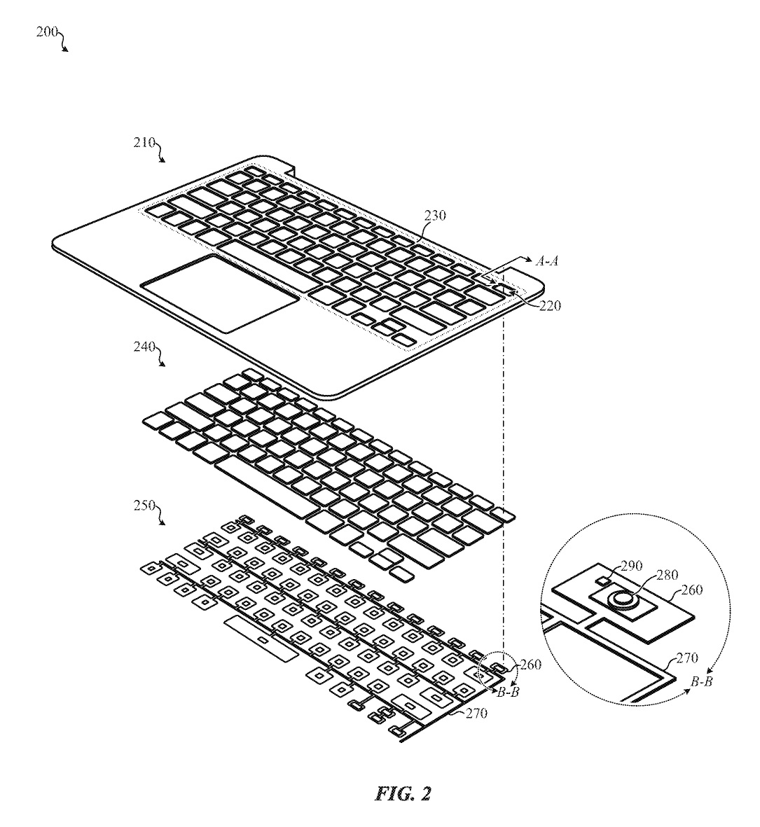

FIG. 2 illustrates an exploded view of an example keyboard assembly 200 according to one or more embodiments of the present disclosure. The keyboard assembly 200 may be used with an electronic device, such as, for example, a laptop computer shown in FIG. 1 or other such electronic device.

The keyboard assembly 200 includes a top case 210. The top case 210 may take the form of an exterior protective casing or shell for the electronic device. The top case 210 may also protect the various internal components of the electronic device including a keyboard stack-up array 250.

Top case 210 may be formed as a single, integral component. The top case 210 may be coupled to a bottom case which is not shown for clarity. The top case 210 may have a group of distinct components that may be configured to be coupled to one another. In non-limiting examples, top case 210 may be made from metal, a ceramic, a rigid plastic or another polymer, a fiber-matrix composite, and so on.

The top case 210 may define or otherwise include one or more openings or keyholes 220. The keyholes 220 may be configured to receive keycaps 240 that are associated with each key of a keyboard. The keycaps 240 may partially protrude or otherwise extend from the top case 210 through the keyholes 220. In addition, each keycap 240 may be at least partially surrounded by a portion of the top case 210. Stated another way, the keyholes 220 that are formed in the top case 210 cause ribs 230 to be formed in the top case 210. The ribs 230 are positioned between the keycaps 240 to divide and separate each key of the keyboard. The ribs 230 may provide structural support for the top case 210.

The keyboard assembly 200 also includes a keyboard stack-up array 250. The keyboard stack-up array 250 includes multiple keyboard stack-ups 260 (shown in detail in B-B) secured within or otherwise coupled to a frame 270. In some implementations, the frame 270, or portions of the frame 270 may be flexible or bendable. For example, different portions of the frame 270 may be coupled to individual keyboard stack-ups 260. As such, the frame 270 may enable each individual keyboard stack-up 260 to move independently of one another. Thus, each keyboard stack-up 260 may be inserted into respective keyholes 220 and supported by a support structure of the top case 210.

Each keyboard stack-up 260 in the keyboard stack-up array 250 may be similar to the keyboard stack-up described below. That is, each keyboard stack-up 260 may include a substrate, an in-plane switch (not shown) a dome 280 positioned over the in-plane switch, a light source 290, a signal trace and a power trace.

The frame 270 may have similar pattern or structure as the ribs 230 of the top case 210. Accordingly, the frame 270 may provide added structural support for the top case 210. The frame 270 may have various signal traces and/or power traces formed thereon for each light source 290 and in-plane switch coupled to respective keyboard stack-ups 260.

In alternative embodiments, the keyboard assembly 200 may be used to create a flexible keyboard. In such embodiments, the top case 210 may be omitted or may be formed from a flexible material. The flexible material, and more specifically the flexible keyboard, may have a maximum bend radius such that components (e.g., traces, switches and so on) of the keyboard assembly are not damaged. In other implementations, each component of the keyboard stack-up 260 may be placed or otherwise coupled to a flex.

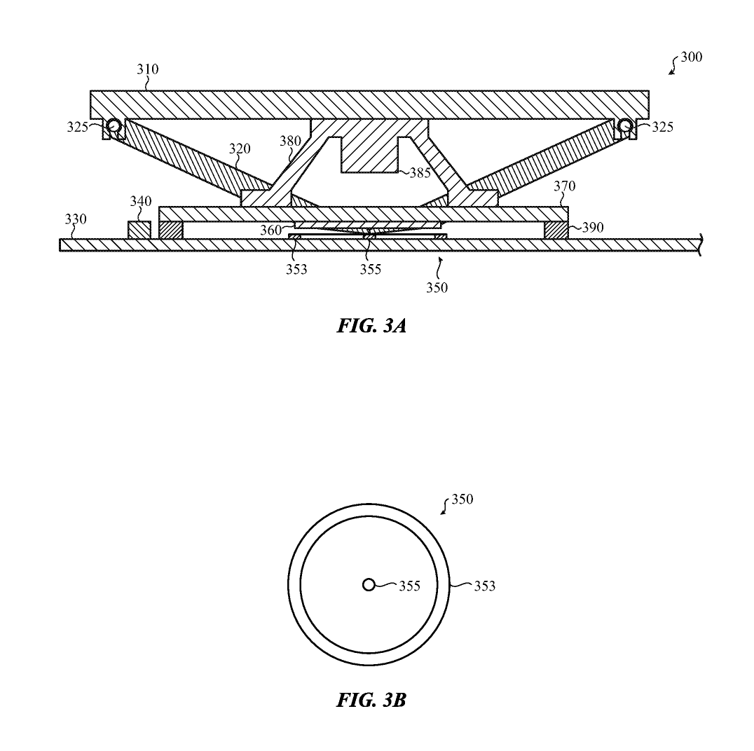

FIG. 3A illustrates an example reduced layer keyboard stack-up 300 including a keycap 310 and a hinge mechanism 320 according to one or more embodiments of the present disclosure. The keycap 310 may be coupled to the hinge mechanism 320 using one or more retaining features 325. The hinge mechanism 320 enables the keycap 310 to move from an uncompressed state to a compressed state and vice versa. Example hinge mechanisms 320 include, but are not limited to, a butterfly hinge mechanism, a scissor hinge mechanism, a telescoping hinge mechanism, a sliding hinge mechanism and so on. The hinge mechanism 320 may also be coupled to a substrate 330 of the keyboard stack-up 300.

The substrate 330 of the keyboard stack-up 300 may be flexible. In other implementations, the substrate 330 may be a printed circuit board. The various layers (including additional plastic or deflection layers not shown in the figures) of the keyboard stack-up 300 may be laminated or otherwise coupled to a printed circuit board or a flex. Further, some of the connections or traces may be provided on or otherwise formed on the printed circuit board and/or the flex and provided to the components of the keyboard stack-up 300.

Multiple keyboard stack-ups 300 may be coupled together to form a keyboard stack-up array, such as, for example, keyboard stack-up array 250 (FIG. 2). Accordingly, each key of a keyboard may have a discrete keyboard stack-up 300. As such, each key of a keyboard may have its own keycap 310, hinge mechanism 320, light source 340 and so on. Accordingly, each key of the keyboard may be illuminated by its own light source 340 and the illumination of each key may be separately tuned or otherwise adjusted.

Each keyboard stack-up 300 in the array may be inserted into or otherwise coupled to a top case of a keyboard assembly such as described herein. More specifically, a top case of the keyboard assembly may include a ledge or other support structure that is adapted to receive and support an individual keyboard stack-up 300 or multiple keyboard stack-ups 300.

The keyboard stack-up 300 may also include a stiffener. The stiffener may provide additional structural support for the keyboard stack-up 300. The stiffener may be aluminum, stainless steel, plastic or other such material. Stiffeners of varying thicknesses may be used depending on the stiffness of the substrate 330 and/or the desired stiffness of the keyboard stack-up 300. In other implementations, the stiffener may be omitted.

In embodiments where the substrate 330 is a printed circuit board, a stiffener may not be required. Optionally, where the substrate 330 is a flexible substrate (such as a flex circuit), a stiffener may be coupled to the flexible substrate to provide additional structural support for the keyboard stack-up 300 and/or a top case of the electronic device in which the keyboard stack-up 300 is placed. In some embodiments, the flexible substrate or other such flexible material may be coupled to a printed circuit board.

The keyboard stack-up 300 may also include a light source 340. The light source 340 may be coupled to an optional light guide to illuminate the keycap 310. The keycap 310 may also include a glyph on an exposed surface. The glyph may be transparent or substantially transparent to enable light from the light source 340 to pass through the glyph and illuminate the keycap 310. In some implementations, the keycap 310 may be substantially opaque while the glyph is transparent or substantially transparent. In some implementations, the perimeter of the keycap 310 may also be illuminated. The light source 340 is coupled to the substrate 330 and receives power from a power trace that is printed, formed or otherwise disposed in or on the substrate 330. In some embodiments, the light source 340 is a light-emitting diode although other light sources may be used.

The keyboard stack-up 300 also includes an in-plane switch 350. Although an in-plane switch 350 is specifically mentioned, various switches may be used. The in-plane switch 350 may be coupled to the substrate 330. In some implementations, the base of the in-plane switch 350 may be the substrate 330. For example, and as previously explained, the substrate 330 may be a flexible substrate or a flex and the flexible substrate or the flex is the base of the in-plane switch 350.

The contacts (e.g., outer contact 353 and inner contact 355) of the in-plane switch 350 may be planar or substantially planar with respect to a surface of the substrate 330. In other implementations, the contacts of the in-plane switch 350 may protrude or extend from the substrate 330. In yet other implementations, the contacts may be recessed with respect to the substrate 330.

The in-plane switch 350 may include two (or more) contacts. Specifically, the in-plane switch 350 may have an outer contact 353 and an inner contact 355. As shown in FIG. 3B, which is a top-down view of the in-plane switch 350, the outer contact 353 and the inner contact 355 may be concentric. That is, the inner contact 355 may be surrounded by the outer contact 353.

In some implementations a trace may connect the inner contact 355 with the outer contact 353. Thus, contact by a conductive material on either the inner contact 355 or the outer contact 353 may cause the in-plane switch 350 to conduct a signal. In other implementations, each of the inner contact 355 and outer contact 353 may have separate traces. In such an implementation, a signal is conducted when a conductive material contacts both the inner contact 355 and the outer contact 353. Because the traces are in-plane with the contacts or may otherwise be formed in or on the substrate 330, the outer contact 353 may have a gap that allows the trace of the inner contact 355 to connect with the inner contact 355 but not the outer contact 353.

Referring back to FIG. 3A, when a conductive material 360, such as, for example a silver pad, contacts the inner contact 355 and/or the outer contact 353 (depending on the implementations described above) of the in-plane switch 350 though actuation of the keycap 310 and/or collapse of the dome 380, the conductive material 360 bridges the contacts to create an electrical connection. The electrical connection generates a signal indicative of the received input. In other implementations, the conductive material 360 may short a connection or otherwise draw power down between the inner contact 355 and the outer contact 353 thereby generating a signal indicative of received input.

Although a silver pad is specifically mentioned in the example above, other conductive materials may be used. In addition, once the signal is generated, it may be transmitted on a signal trace formed on, integrated with or otherwise printed on the substrate 330.

The keyboard stack-up 300 also includes a dome 380 coupled to a deflection layer 370 and positioned over the in-plane switch 350. The dome 380 and the deflection layer 370 may also be placed over the light source 340. As such, one or both of the dome 380 and the deflection layer 370 may be transparent or at least partially transparent and may act as a light guide such that light may pass though and illuminate the keycap 310.

The deflection layer 370 may include a conductive material positioned in and/or on a bottom surface. The deflection layer 370 may be thermoplastic polymer such as, for example, polyethylene terephthalate. Although a specific example has been given, the deflection layer 370 may be made from various materials.

In some embodiments, the dome 380 is a rubber dome. In other embodiments, the dome may be a plastic dome, a metal dome or may be made from various other materials. The dome 380 is configured to collapse, be deformed or otherwise compress in response to actuation of the dome 380 and/or the keycap 310. While a dome 380 is specifically shown and described, the dome 380 may be optional or may be replaced by a spring, a plunger on a keycap 310 and other such mechanisms that may be used to deflect or actuate the deflection layer 370 or bridge the contacts of the in-plane switch 350.

As the dome 380 is compressed, a nub 385 or other portion of the dome 380 causes the deflection layer 370, and more specifically, the conductive material 360 on the bottom surface of the deflection layer 370, to deflect toward the contacts of the in-plane switch 350. Once the conductive material 360 comes into contact with the contacts of the in-plane switch 350, a signal indicative of which key or button of the electronic device has been actuated is generated and transmitted along the signal trace of the substrate 330 to an associated electronic device or a dedicated processing element in the keyboard. When the dome 380 returns to its nominal state, the deflection layer 370 also returns to its nominal state and the conductive material 360 is removed from the contacts of the in-plane switch 350.

The keyboard stack-up 300 may also have one or more spacers 390 positioned between the substrate 330 and the deflection layer 370. The spacers 390 may be used to provide separation between the conductive material 360 and the contacts of the in-plane switch 350. In addition, the spacers 390 may assist the deflection layer 370 in returning to its nominal state.

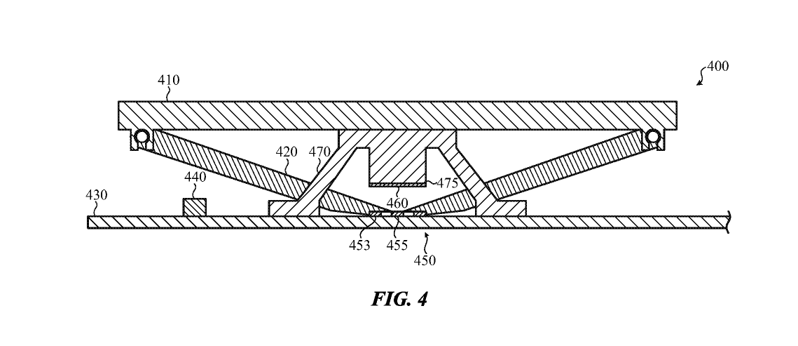

FIG. 4 illustrates an example reduced layer keyboard stack-up 400 according to one or more alternate embodiments of the present disclosure. The reduced layer keyboard stack-up 400 is generally the same as the reduced layer keyboard stack-up 300 shown and described with respect to FIG. 3A but without the deflection layer 370.

As such, the reduced layer keyboard stack-up 400 includes a keycap 410, a hinge mechanism 420, a substrate 430, an optional light source 440, and an in-plane switch 450. The light source 440 is configured to illuminate the keycap 410 while the in-plane switch 450 is configured to detect actuation of keycap 410 and/or dome 470 of the keyboard stack-up 400. The contacts of the in-plane switch 450 may be concentric. For example, the in-plane switch 450 may have an outer contact 453 and an inner contact 455. The substrate 430 may also include a power trace for providing power to the light source 440 and may include a signal trace for transmitting a signal generated by the in-plane switch 450.

The substrate 430 of the keyboard stack-up 400 may be flexible. In other implementations, the substrate 430 is a printed circuit board. One or more stiffening layers (not shown) may also be applied to various parts of the keyboard stack-up 400 such as described above. The keyboard stack-up 400 also includes a dome 470. The dome 470 may be similar to the dome 380 described above. The dome 470 may be directly coupled, laminated or adhered to the flex or substrate 430.

The keyboard stack-up 400 does not include a deflection layer as the keyboard stack-up 300 of FIG. 3A. However, in lieu of a deflection layer, the dome 470 may include a conductive material 460 disposed on a nub 475 or other surface of the dome 470. In some implementations, the conductive material 460 may be co-molded or otherwise integrated with the dome 470. In other implementations, the conductive material 460 is surface mounted to the dome 470. In yet other implementations, the conductive material 460 may be painted, etched or printed on the nub 475 or other surface of the dome 470. As with the conductive material disclosed above, the conductive material 460 in the present embodiment may be configured to bridge a connection between the contacts of the in-plane switch 450 when the keycap 410 and/or the dome 470 is actuated or collapsed.

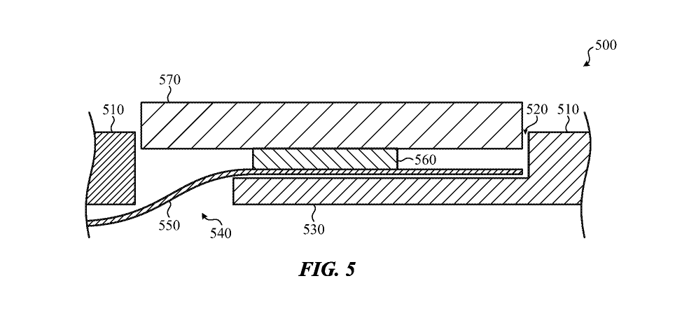

FIG. 5 illustrates a cross-section view of an example keyboard assembly 500 according to one or more embodiments of the present disclosure. The cross-section view shown in FIG. 5 may be taken along A-A of FIG. 2 when the keyboard assembly 200 is assembled.

The keyboard assembly 500 may include a top case 510. The top case 510 may have a first thickness and may further include a keyhole 520 and a support structure 530. The support structure 530 may have a thickness that is less than the thickness of the top case 510.

In some embodiments, the support structure 530 may extend from the top case 510 and may also provide structural support for the top case 510. More specifically, the support structure 530 may extend from the top case 510 and may also extend at least partially into the keyhole 520 to form a ledge. The support structure 530 also defines an opening 540 on a bottom surface of the top case 510. The support structure 530 also supports the substrate 550 (or flex) and the dome of the keyboard stack-up 560.

The opening 540 receives a keyboard stack-up 560 which may be placed on or coupled to the ledge of the support structure 530 such that the support structure is underneath substrate of the keyboard stack-up 560. For example, a respective keyboard stack-up 560 of a keyboard stack-up array (such as the keyboard stack-up array 250 shown in FIG. 2) may be inserted or otherwise threaded through the opening 540 on a bottom of the top case 510. Once inserted, a keycap 570 may be coupled to the keyboard stack-up 560 via the keyhole 520 disposed on a top surface of the top case 510. As such, the support structure 530 provides structural support for the keyboard stack-up 560 and also provides structural support for the keyboard assembly 500.

For example, the support structure 530 may prevent undesired deflection of the keyboard stack-up 560 during use and/or during manufacture and may also prevent a keycap 570 from plunging under the top case 510 or under the ribs (e.g., ribs 230 of FIG. 2) of the top case 510.

As with the other keyboard stack-ups described herein, the keyboard stack-up 560 operates as previously described.

The keyboard stack-up 560, and more specifically the components of the keyboard stack-up 560 may be sealed (e.g., liquid sealed) to the substrate 550 of the keyboard stack-up 560. In some embodiments, the keyboard stack-up 560 may also include one or more air pockets or vents on a bottom surface that permit the structure to cool and to evacuate air under the dome when the dome collapses.

Although discussed herein as a keyboard assembly, it is understood that the disclosed embodiments can be used as an input assembly for any depressible input mechanism such as, for example, a button, and may be used in a variety of input devices and/or electronic devices. That is, the keyboard stack-up, and the components of the keyboard stack-up disclosed herein may be utilized or implemented in a variety of input devices for an electronic device including, but not limited to buttons, switches, toggles, wheels, touch screens and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

1.-20. (canceled)

21. A keyboard assembly comprising:
a top case defining an array of depressions along a top surface;
a key mechanism disposed at least partially in a depression of the array of depressions;
a keycap disposed above the key mechanism; and
a sensor disposed below the key mechanism and configured to generate a signal in response to an input received at the keycap.

22. The keyboard assembly of claim 21, wherein:
the key mechanism is a first key mechanism;
the depression is a first depression;
the keycap is a first keycap;
the sensor is a first sensor;
the signal is a first signal;
the input is a first input; and
the keyboard assembly further comprises:
a second key mechanism disposed at least partially in a second depression of the array of depressions;
a second keycap disposed above the second key mechanism; and
a second sensor disposed below the second key mechanism and configured to generate a second signal in response to a second input received at the second keycap, wherein the keycap and the second keycap define keys of a keyboard.

23. The keyboard assembly of claim 21, further comprising a dome positioned above the sensor and configured to collapse in response to actuation of the keycap.

24. The keyboard assembly of claim 21, wherein the top case is formed of a dielectric material.

25. The keyboard assembly of claim 21, wherein the top case is formed of at least one of a plastic, a ceramic, or a polymer.

26. The keyboard assembly of claim 21, further comprising a flexible substrate disposed beneath the key mechanism and configured to transmit an input signal from the sensor.

27. The keyboard assembly of claim 21, further comprising a light source positioned beneath the keycap.

28. The keyboard assembly of claim 27, wherein:
the keyboard assembly further comprises a flexible substrate disposed beneath the key mechanism;
the light source is coupled to the flexible substrate; and
the flexible substrate comprises a power trace for providing power to the light source.

29. A keyboard comprising:
a ceramic top case defining a depression;
a keycap positioned over the depression;
a sensor disposed beneath the keycap and configured to detect an input at the keycap;
a light source disposed beneath the keycap; and
a flex connector disposed beneath the depression and comprising:
a power trace coupled to the light source; and
a signal trace coupled to the sensor.

30. The keyboard of claim 29, wherein:
the keycap is a first keycap;
the depression is a first depression;
the sensor is a first sensor;
the input is a first input;
the ceramic top case defines an array of depressions that includes the first depression; and
the keyboard further comprises:
a second keycap positioned over a second depression of the array of depressions; and
a second sensor disposed beneath the second keycap and configured to detect a second input at the second keycap.

31. The keyboard of claim 30, wherein the first keycap and the second keycap define keys of the keyboard.

32. The keyboard of claim 29, further comprising an actuation member disposed in the depression and configured to actuate in response to the input at the keycap.

33. The keyboard of claim 32, wherein the actuation member comprises a key mechanism coupled to the keycap.

34. The keyboard of claim 32, wherein the actuation member comprises a compressible structure.

35. The keyboard of claim 29, further comprising a deflection layer disposed beneath the keycap and configured to deflect in response to a force applied at the keycap.

36. An electronic device comprising:
a top case defining an array of depressions;
a set of key mechanisms including a key mechanism disposed in a respective depression of the array of depressions;
a set of keycaps including a keycap positioned above the key mechanism of the set of key mechanisms; and
a sensor disposed beneath the keycap of the set of keycaps, wherein:
the set of keycaps defines a keyboard of the electronic device; and
the sensor is configured to output a signal in response to an input at the keyboard.

37. The electronic device of claim 36, further comprising a processing element disposed in a housing of the electronic device and operably coupled to the sensor.

38. The electronic device of claim 36, wherein:
the electronic device further comprises a set of sensors that includes the sensor; and
each sensor of the set of sensors is positioned beneath a different keycap of the set of keycaps.

39. The electronic device of claim 36, further comprising a light source configured to illuminate the at least one keycap.

40. The electronic device of claim 36, wherein:
the electronic device further comprises a set of light sources; and
each light source of the set of light sources is configured to illuminate a different keycap of the set of keycaps.
